(19) United States
(12) Patent Application Publication
(10) Pub. No.: US 2025/0314121 A1
(43) Pub. Date: Oct. 9, 2025

(54) UNIVERSAL PULTRUDED FIBERGLASS TUBE

(71) Applicant: DuraServ LLC, Carrollton, TX (US)

(72) Inventor: Eddie Johnston, Dalton, OH (US)

(73) Assignee: DuraServ LLC, Carrollton, TX (US)

(21) Appl. No.: 18/627,680

(22) Filed: Apr. 5, 2024

(51) Int. Cl. E06B 7/23

(52) U.S. Cl. CPC E06B 7/2309; E06B 7/2314

(57) ABSTRACT

A tube may comprise a plurality of walls configured to form a groove at each corner of the tube, with each groove being configured to receive a seal such as weatherstripping to seal an opening around a portion of a door. The grooves may be uniform, such that the same tube may be used in multiple different applications or configurations. The tube may be formed from a fiberglass material with a polyurethane resin base.

### TECHNICAL FIELD

The present disclosure relates to fiberglass tubes used for providing a compression seal.

### BACKGROUND

A door is used to control access to an opening, but often may not fully seal within the opening, in which case additional components are required to fully seal the opening. Weatherstripping is the process of sealing openings such as doors and windows from outside elements. Advantageously, weatherstripping is used in buildings to keep out weather, increase interior comfort, lower utility bills, and reduce noise. Often times, weatherstripping or a compression seal is used to provide a seal between the floor and a door. Conventionally, a piece of material is installed on the bottom of the door that is capable of receiving the seal or weatherstripping. These materials are often designed for a specific configuration and are not adaptable for different applications.

Weatherstripping can also be used to seal between garage door panels. Seals in such an application can be difficult to assemble or configure based on the location relative to the other panels. Similar to the application of sealing in doors, components of garage doors (e.g., structural tubes) may only be configured to be installed and/or receive seals in certain orientations. For example, the product needed to provide a seal between panels would not be able to provide a seal between the panel and the floor. This variability requires the production of different variations of the same component, which can be costly and require a larger variety of components to be kept in inventory.

In choosing a material to adhere weatherstripping to a door, several factors are considered, including thermal performance, moisture protection, durability, and sustainability. Historically, materials such as aluminum and steel have been used, but they may develop rust over time, and are not thermally efficient in comparison to other materials.

Plastics such as polyethylene and polyurethane became a popular material choice in the late 1930s. Plastics are easy to clean, easy to maintain, impact resistant, corrosion resistant, eco-friendly, and water-resistant.

Polyethylene has a lower specific gravity than steel, resulting in a lighter product, which makes transportation and installation easier. Despite polyethylene's low specific gravity, polyethylene still has comparable strength and durability to steel. Further, as polyethylene processes developed, plastic became a more cost-effective option than steel, and polyethylene can be easily recycled. Although polyethylene is slightly weaker and less durable than steel, the additional benefits of polyethylene make it a competitive material choice. Further, polyethylene can be used as a resin that may be blended with additives. These additives can increase the strength and durability of polyethylene, and overcome some of polyethylene's shortcomings in comparison to steel.

Fiberglass is another recently popular material choice. Fiberglass is more rigid and lighter than polyethylene. This increased rigidity however, makes fiberglass sheets more prone to cracking. Fiberglass sheets also frequently have seams, which can create a weak point in the sheet. Unlike fiberglass and steel, polyethylene sheets do not have seams or weld points. However, fiberglass has many advantages similar to polyethylene that are important in construction of materials such as being easy to clean, easy to maintain, and water-resistant. As a result, fiberglass is a popular additive for thermoset resins resulting in fiberglass reinforced plastics or FRPs. FRPs consist of a plastic material reinforced with glass fibers, and are frequently referred to as simply fiberglass in the commercial setting. The addition of FRPs and fiberglass can increase plastic thermal flexibility, strength, durability, and temperature sensitivity. However, FRPs are extremely difficult to recycle due to their composition. Although fiberglass by itself can be recycled by grinding, it is generally difficult to break down the fibers, and the problem is exacerbated when plastic and fiberglass are mixed together. Thermoset resins make the process even more difficult because they do not melt at high temperatures. Although there are methods to recycle FRPs, none are particularly cost-effective. Recycling polyethylene by itself, is a much more cost-effective process.

Polyurethane has unique stretching properties and can be stiff or flexible. Polyurethane is also preferred for applications that require heat resistance or capability to withstand harsh conditions.

Therefore, what is desired is a component that can be used to adhere weatherstripping in multiple different applications or configurations, and which is affordable, durable, and strong.

### SUMMARY

In one embodiment, the invention may comprise a tube configured to receive a seal, the tube comprising a plurality of walls, wherein the plurality of walls comprises at least: a first wall; a second wall, the second wall perpendicular to the first wall; a third wall, the third wall parallel to the first wall; a fourth wall, the fourth wall parallel to the second wall; a first corner wall coupling the first wall to the second wall, wherein the first corner wall, the first wall, and the second wall cooperatively define a first groove; a second corner wall configured to connect the second wall to the third wall, wherein the second corner wall, the second wall, and the third wall cooperatively define a second groove; a third corner wall configured to connect the third wall to the fourth wall, wherein the third corner wall, the third wall, and the fourth wall cooperatively define a third groove; and a fourth corner wall configured to connect the fourth wall to the first wall, wherein the fourth corner wall, the fourth wall, and the first wall cooperatively define a fourth groove; and wherein the tube is comprised of a fiberglass material with a polyurethane resin base.

In another embodiment, the invention may comprise a panel comprising a panel body having a top edge and a bottom edge; a first tube positioned along the top edge of the panel body, the first tube comprising: a plurality of walls, wherein the plurality of walls comprises at least: a first wall; a second wall, the second wall perpendicular to the first wall; a third wall, the third wall parallel to the first wall; a fourth wall, the fourth wall parallel to the second wall; a first corner wall coupling the first wall to the second wall, wherein the first corner wall, the first wall, and the second wall cooperatively define a first groove; a second corner wall configured to connect the second wall to the third wall, wherein the second corner wall, the second wall, and the third wall cooperatively define a second groove; a third corner wall configured to connect the third wall to the fourth wall, wherein the third corner wall, the third wall, and the fourth wall cooperatively define a third groove; and a fourth corner wall configured to connect the fourth wall to the first wall, wherein the fourth corner wall, the fourth wall, and the first wall cooperatively define a fourth groove; and wherein the tube is comprised of a fiberglass material with a polyurethane resin base.

In yet another embodiment, the invention may comprise a garage door comprising: a plurality of panels, wherein the plurality of panels comprises at least: a first panel, wherein the first panel has a top edge and a bottom edge; a second panel, wherein the second panel has a bottom edge adjacent to the top edge of the first panel; a third panel, wherein the third panel has a top edge adjacent to the bottom edge of the first panel; and a first tube positioned along the top edge of the first panel, the first tube further comprising: a plurality of walls, wherein the plurality of walls comprises at least: a first wall; a second wall, the second wall perpendicular to the first wall; a third wall, the third wall parallel to the first wall; a fourth wall, the fourth wall parallel to the second wall; a first corner wall coupling the first wall to the second wall, wherein the first corner wall, the first wall, and the second wall cooperatively define a first groove; a second corner wall configured to connect the second wall to the third wall, wherein the second corner wall, the second wall, and the third wall cooperatively define a second groove; a third corner wall configured to connect the third wall to the fourth wall, wherein the third corner wall, the third wall, and the fourth wall cooperatively define a third groove; and a fourth corner wall configured to connect the fourth wall to the first wall, wherein the fourth corner wall, the fourth wall, and the first wall cooperatively define a fourth groove; and wherein the tube is comprised of a fiberglass material with a polyurethane resin base; a second tube positioned along the bottom edge of the first panel, wherein the second tube is uniform with the first tube; a third tube positioned along the bottom edge of the second panel, wherein the third tube is uniform with the first tube; and a fourth tube positioned along the top edge of the third panel, wherein the fourth tube is uniform with the first tube.

### BRIEF DESCRIPTION OF DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is an exemplary embodiment of a door with universal pultruded fiberglass tubes.

FIG. 2A is an exemplary embodiment of a non-insulated panel structure.

FIG. 2B is an exemplary embodiment of an insulated panel structure.

FIG. 3 is a side perspective of a universal pultruded fiberglass tube with weatherstripping.

FIG. 4 is a cross sectional view of a universal pultruded fiberglass tube.

### DETAILED DESCRIPTION

The present disclosure relates generally to a compression seal, and more particularly, to a universal fiberglass tube compression seal. As described herein, embodiments of the universal fiberglass tube improve upon conventional compression seals.

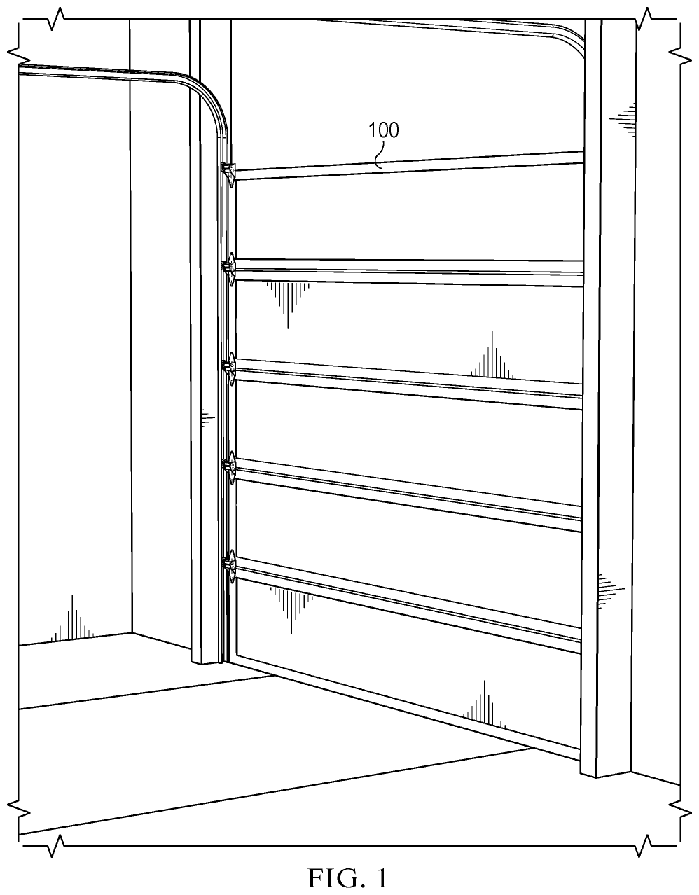

Conventionally, compression seals can be used to provide a seal between the floor and a door, as well as between door panels. As shown in FIG. 1, a plurality of universal tubes (U-tubes) can be coupled to a various panels (e.g., garage door panels). Advantageously, the U-tubes can be used as a compression seal between door panels as well as between the bottom door panel and the floor. In certain applications, the U-tubes can be used to provide insulation to the door panels. Embodiments of the U-tubes include design features to allow for easy installation and maintenance, and flexible operation of this equipment. Certain embodiments of the U-tubes can be tailored to use with a garage door.

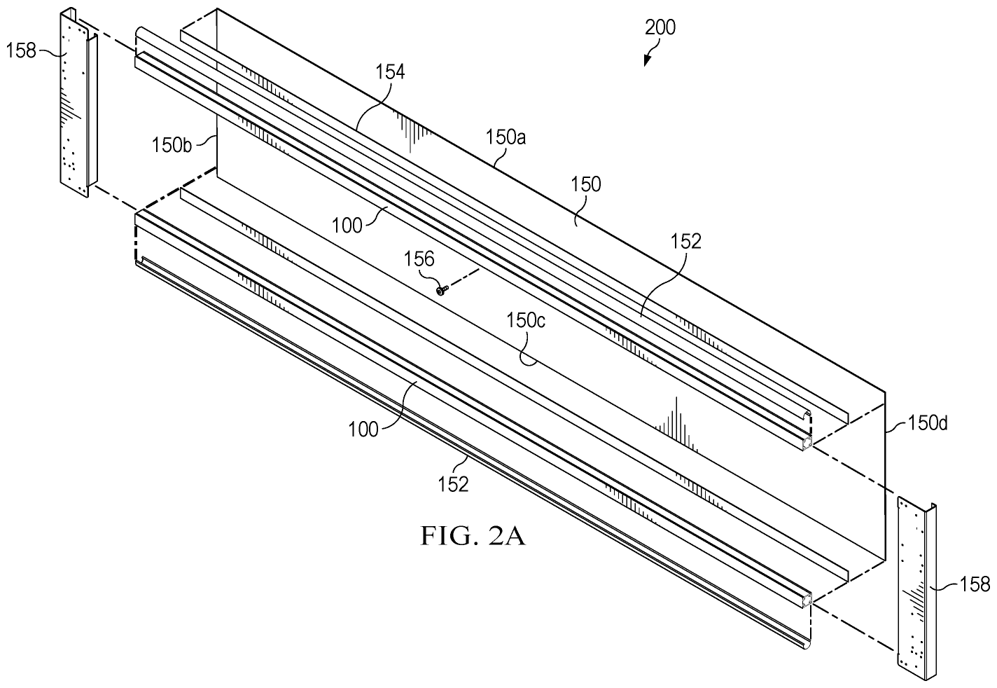

Referring to FIG. 2A, an exemplary embodiment of a non-insulated panel structure 200 is shown. In the depicted example, the non-insulated panel structure 200 includes a panel 150 coupled to a U-tube 100. The U-tube 100 receives a seal 152, which provides a compression seal between the panel 150 and adjacent structures. Advantageously, the U-tube 100 is configured to receive a seal in multiple configurations, as will be discussed in more detail below. As illustrated, the panel 150 has a rectangular configuration with a top edge 150a, a left edge 150b, a bottom edge 150c, and a right edge 150d. In certain embodiments, the top edge 150a and bottom edge 150c have lengths greater than the height of the left edge 150b and right edge 150d. In certain embodiments the panel 150 is made of a steel laminated composite sheet material and is at least 3 mm thick.

As illustrated, an end cap 158 receives the left edge 150b of the panel. Advantageously, the end cap 158 reinforces and protects the left edge 150b of the panel. As illustrated, an end cap 158 receives the right edge 150d of the panel. Advantageously, the end cap 158 reinforces and protects the right edge 150d of the panel. In some embodiments, the end caps 158 are made of steel. As will be discussed in more detail below, the U-tube 100 is comprised of four walls. In the depicted example, the U-tube 100 can be coupled to the panel 150. For example, a wall of the U-tube 100 can be coupled to an edge of the panel 150 with structural tape 154 and a single bolt 156. A person of skill in the art would understand that other methods could be used to couple the U-tube 100 to the panel 150. As illustrated a first U-tube 100 can be coupled to the top edge 150a of the panel and a second U-tube 100 can be coupled to the bottom edge 150c of the panel 150. Advantageously, the U-tube 100 has the same orientation whether it is attached to the top edge 150a of the panel 150 or the bottom edge 150c.

Referring to FIG. 2B, an exemplary embodiment of an insulated panel structure 200 is shown. In the depicted example, the insulated panel structure 300 includes a panel 350, an interior insulating panel 360, and an exterior insulating panel 370. The interior insulated panel 360 and the exterior insulating panel 370 are coupled to a U-tube 100. The U-tube 100 receives a seal 152, which provides a compression seal between the panel 350 and adjacent structures. Advantageously, the U-tube 100 is configured to receive a seal in multiple configurations, as will be discussed in more detail below. Similar to the panel 150 shown above, the panel 350 has a rectangular configuration with a top edge 350a, a bottom edge 350c, a left edge 350b, and a right edge 350d. In certain embodiments, the top edge 350a and bottom edge 350c have lengths greater than the height of the left edge 350b and right edge 350d. In certain embodiments the panel 350 is made of an expanded polystyrene (EPS) material and is at least 3 mm thick. In some embodiments, the panel 350 can be as thick as 1-½ in thick.

As illustrated in FIG. 2B, the panel 350 can be insulated with an interior insulating panel 360 and an exterior insulating panel 370. Similar to the panel 350, the interior insulating panel 360 has a rectangular configuration with a top edge 360a, a bottom edge 360c, a left edge 360b, and a right edge 360d. In certain embodiments, the top edge 360a and bottom edge 360c have lengths greater than the height of the left edge 360b and right edge 360d. Similar to the panel 350, the exterior insulating panel 370 has a rectangular configuration with a top edge 370a, a bottom edge 370c, a left edge 370b, and a right edge 370d. In certain embodiments, the top edge 370a and bottom edge 370c have lengths greater than the height of the left edge 370b and right edge 370d. In this embodiment, the interior insulating panel 360 and exterior insulating panel 370 have a plurality of holes along the top edges 360a and 370a and the bottom edges 360c and 370c extending from the left edges 360b and 370b to the right edges 360d and 370d.

The U-tube 100 is comprised of four walls. In the depicted example, the U-tube 100 includes a set of holes along the face of at least two opposite walls. In this embodiment, the holes are positioned along the length of the U-tube 100.

Advantageously, the holes along the top edge and the bottom edge of the interior insulating panel 360 and the exterior insulating panel 370 align with the holes of the U-tube 100. As illustrated a first U-tube 100 can be coupled to the top edges 360a and 370a of the interior insulating panel 360 and exterior insulating panel 370 respectively and a second U-tube 100 can be positioned along the bottom edges 360c and 370c of the interior insulating panel 360 and exterior insulating panel 370 respectively. Advantageously, the U-tube 100 has the same orientation whether it is positioned along the top edges 360a and 370a of the interior insulating panel 360 and exterior insulating panel 370 respectively or the bottom edges 360c and 370c of the interior insulating panel 360 and exterior insulating panel 370 respectively. In this embodiment the holes of the interior panel 360, exterior panel 370, and U-tube 100 receive a bolt so that the interior insulating panel 360 and the exterior insulating panel 370 can be coupled to the U-tube 100 such that the U-tube 100 is sandwiched between the interior insulating panel 360 and the exterior insulating panel 370. In some embodiments, the interior insulating panel 360 and the exterior insulating panel 370 are coupled to the U-tube 100 with structural tape. A person of ordinary skill in the art would understand that insulating panels 360 and 370 can be coupled to the U-tube 100 with various methods.

As illustrated, an end cap 158 receives the left edge 350b of the panel 350, as well as the left edge of the interior insulating panel 360, and the left edge of the exterior insulating panel 370. Advantageously, the end cap 158 reinforces and protects the left edge 350b of the panel 350, the edge of the interior insulating panel 360, and the edge of the exterior insulating panel 370. As illustrated, an end cap 158 receives the right edge 350c of the panel 350, as well as the right edge of the interior insulating panel 360, and the right edge of the exterior insulating panel 370. Advantageously, the end cap 158 reinforces and protects the right edge 350c of the panel 350, the edge of the interior insulating panel 360, and the edge of the exterior insulating panel 370.

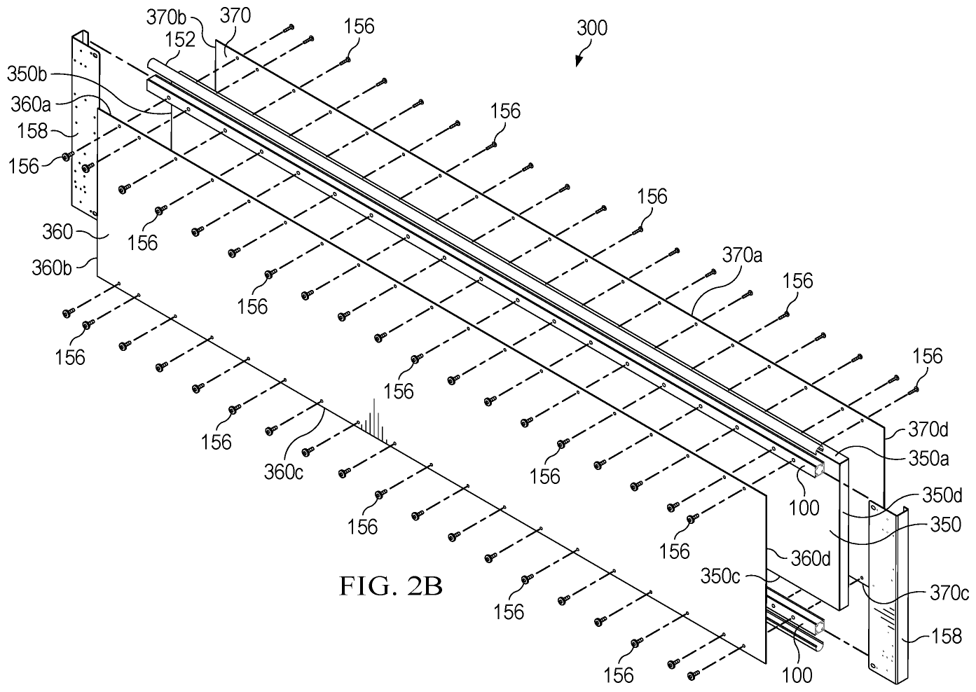

As illustrated in FIG. 3 and as discussed above, the U-tube 100 is configured to receive a seal 152. As will be discussed in further detail below, the U-tube 100 has a set of grooves that are configured to receive the seal 152. In some embodiments, the seal is an EPDM seal.

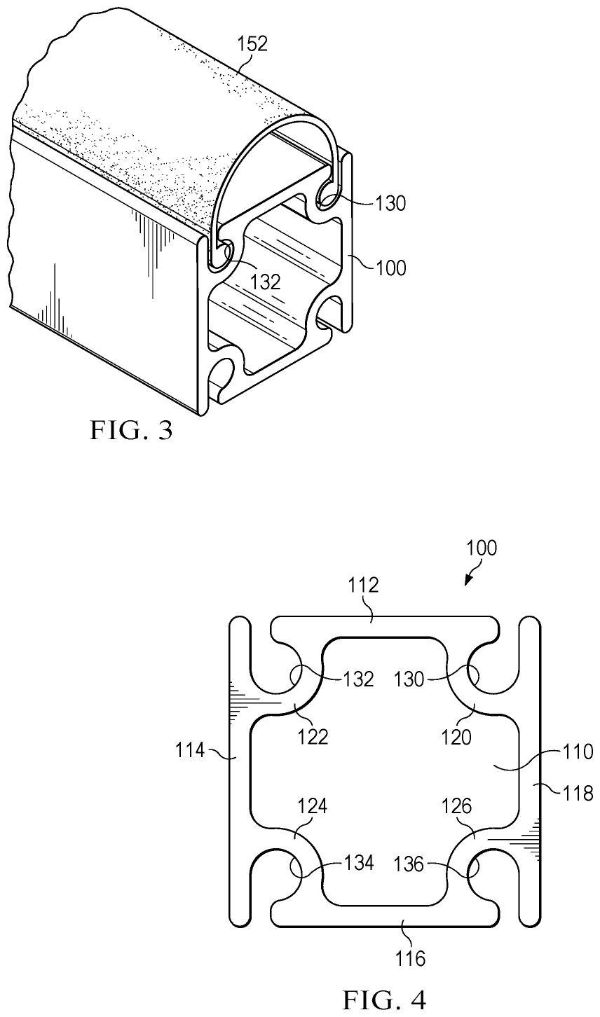

Referring to FIG. 4, a cross-sectional view of the U-tube 100 is shown. As discussed above, the U-tube 100 is a universal tube and can be used in a range of applications. For example, the U-tube can be used between the door and the floor as well as between door panels. In the depicted example, the U-tube 100 includes a plurality of walls. The U-tube 100 includes a first wall 112, a second wall 114, a third wall 116, and a fourth wall 118. In this embodiment, the first wall 112 and third wall 116 are of equal length. The second wall 114 and the fourth wall 118 are of a second equal length. In certain embodiments, the second wall 114 and fourth wall 118 are 1 ½″ long. In this embodiment, the length of the first wall 112 and third wall 116 is less than the length of the second wall 114 and the fourth wall 118. The first wall 112, second wall 114, third wall 116, and fourth wall 118 are arranged to form a square shape such that the second wall 114 is perpendicular to the first wall 112 and the third wall 116 is parallel to the first wall 112. As illustrated in FIG. 4, the plurality of walls do not touch. In this embodiment, the plurality of walls are connected by a plurality of corner walls. As illustrated in FIG. 4, a first corner wall 122 couples the first wall 112 to the second wall 114, wherein the first wall 112, the second wall 114, and the first corner wall 122 define a first groove 132. A second corner wall 124 couples the second wall 114 to the third wall 116 in a similar manner, wherein the second wall, 114, the third wall 116, and the second corner wall 124 define a second groove 134. A third corner wall 126 couples the third wall 116 to the fourth wall 118 in a similar manner, wherein the third wall 116, the fourth wall 118, and the third corner wall 126 define a third groove 136. A fourth corner wall 120 couples the fourth wall 118 to the first wall 112 in a similar manner, wherein the first wall 112, the fourth wall 118, and the fourth corner wall 120 define a fourth groove 130. In this embodiment, the plurality of walls and plurality of corner walls define an internal cavity 110. The first groove 132, the second groove 134, the third groove 136, and the fourth groove 130 are equal in size and shape. The grooves 132, 134, 136, and 130 are defined to have a rounded hook shape with a straight section extending to a circular section. In this embodiment, the circular section has a radius of ⅛ inch. Advantageously, the grooves 132, 134, 136, and 130 are designed to receive a seal. In some embodiments, the seal extends through the straight section of the groove and then curls or hooks into the circular section such that the seal is secured to the U-tube 100.

Advantageously, the first wall 112, the second wall 114, the third wall 116, the fourth wall 118, the first corner wall 122, the second corner wall 124, the third corner wall 126, and the fourth corner wall 120 all have a uniform thickness. In certain embodiments, the plurality of walls are 1/10 inch thick. In certain embodiments, the U-tube 100 is made of a fiberglass material. In some embodiments, the fiberglass material is formed in a pultrusion process with a polyurethane resin base. Advantageously, the polyurethane resin base may improve the strength of the U-tube. The strength of the U-tube 100 provides structural support to the panels, allows for compression between the panels, and reduces the transfer of load between the panels. In some applications, the U-tube can withstand a deflection of up to 18 inches without permanent damage. Advantageously, the polyurethane resin base also allows for U-tubes of extended lengths up to 12 feet.

Advantageously, the U-tube allows for universal applications. For example, many conventional compression seals are limited to sealing applications between a door and the floor. Because the U-tube has identical grooves defined at all four corners, it is not limited in its application. This flexibility may reduce manufacturing costs, allow for a more aesthetically pleasing product, and reduce the inventory needed for door applications.

It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

1. A tube configured to receive a seal, the tube comprising:
a plurality of walls comprising:
a first wall;
a second wall perpendicular to the first wall;
a third wall parallel to the first wall;
a fourth wall parallel to the second wall;
a first corner wall coupling the first wall to the second wall, wherein the first corner wall, the first wall, and the second wall cooperatively define a first groove;
a second corner wall coupling the second wall to the third wall, wherein the second corner wall, the second wall, and the third wall cooperatively define a second groove;
a third corner wall coupling the third wall to the fourth wall, wherein the third corner wall, the third wall, and the fourth wall cooperatively define a third groove; and
a fourth corner wall coupling the fourth wall to the first wall, wherein the fourth corner wall, the fourth wall, and the first wall cooperatively define a fourth groove; and
wherein the tube is comprised of a fiberglass material with a polyurethane resin base.

2. The tube of claim 1, wherein the plurality of walls define an internal cavity.

3. The tube of claim 2, wherein the internal cavity has a cross shape.

4. The tube of claim 1, wherein the first groove and the fourth groove are configured to cooperatively receive a first seal.

5. The tube of claim 4, wherein the second groove and the third groove are configured to cooperatively receive a second seal.

6. The tube of claim 1, wherein a profile of the first groove comprises a hook shape.

7. The tube of claim 1, wherein the first groove, the second groove, the third groove, and the fourth groove are uniform.

8. The tube of claim 1, wherein the first wall and the third wall are uniform.

9. The tube of claim 1, wherein the first wall is shorter than the second wall.

10. The tube of claim 1, wherein the first wall, the second wall, the third wall, and the fourth wall have the same thickness.

11. The tube of claim 1, wherein the first corner wall, second corner wall, third corner wall, and fourth corner wall are uniform.

12. The tube of claim 1, wherein the first corner wall, second corner wall, third corner wall, and fourth corner wall are curved.

13. The tube of claim 1, wherein the tube is comprised of a fiberglass material with a polyurethane resin base.

14. A panel comprising:
a panel body having a top edge and a bottom edge;
a first tube positioned along the top edge of the panel body, the first tube comprising:
a first wall;
a second wall perpendicular to the first wall;
a third wall parallel to the first wall;
a fourth wall parallel to the second wall;
a first corner wall coupling the first wall to the second wall, wherein the first corner wall, the first wall, and the second wall cooperatively define a first groove;
a second corner wall coupling the second wall to the third wall, wherein the second corner wall, the second wall, and the third wall cooperatively define a second groove;
a third corner wall coupling the third wall to the fourth wall, wherein the third corner wall, the third wall, and the fourth wall cooperatively define a third groove; and
a fourth corner wall coupling the fourth wall to the first wall, wherein the fourth corner wall, the fourth wall, and the first wall cooperatively define a fourth groove.

15. The panel of claim 14, wherein the first tube is coupled to the panel body with structural tape.

16. The panel of claim 14, wherein a second tube is positioned along the bottom edge of the panel body.

17. The panel of claim 14, wherein the first groove and the fourth groove are configured to cooperatively receive a first seal.

18. The panel of claim 17, wherein the second groove and the third groove are configured to cooperatively receive a second seal.

19. The panel of claim 14, wherein the first groove, the second groove, the third groove, and the fourth groove are uniform.

20. The panel of claim 14, wherein the first tube is comprised of a fiberglass material with a polyurethane resin base.

21. The panel of claim 16, wherein the second tube comprises:
a first wall;
a second wall perpendicular to the first wall;
a third wall parallel to the first wall;
a fourth wall parallel to the second wall;
a first corner wall coupling the first wall to the second wall, wherein the first corner wall, the first wall, and the second wall cooperatively define a first groove;
a second corner wall coupling the second wall to the third wall, wherein the second corner wall, the second wall, and the third wall cooperatively define a second groove;
a third corner wall coupling the third wall to the fourth wall, wherein the third corner wall, the third wall, and the fourth wall cooperatively define a third groove; and
a fourth corner wall coupling the fourth wall to the first wall, wherein the fourth corner wall, the fourth wall, and the first wall cooperatively define a fourth groove; and
wherein the second tube is comprised of a fiberglass material with a polyurethane resin base.

22. The panel of claim 21, further comprising:
a first insulating panel connected to a wall of the first tube and a wall of the second tube; and
a second insulating panel connected to a wall of the first tube and a wall of the second tube.

23. A garage door comprising:
a plurality of panels comprising:
a first panel comprising a top edge and a bottom edge;
a second panel comprising a bottom edge adjacent to the top edge of the first panel;
a third panel comprising a top edge adjacent to the bottom edge of the first panel; and
a first tube positioned along the top edge of the first panel, the first tube comprising:
a first wall;
a second wall perpendicular to the first wall;
a third wall parallel to the first wall;
a fourth wall parallel to the second wall;
a first corner wall coupling the first wall to the second wall, wherein the first corner wall, the first wall, and the second wall cooperatively define a first groove;
a second corner wall coupling the second wall to the third wall, wherein the second corner wall, the second wall, and the third wall cooperatively define a second groove;
a third corner wall coupling the third wall to the fourth wall, wherein the third corner wall, the third wall, and the fourth wall cooperatively define a third groove; and
a fourth corner wall coupling the fourth wall to the first wall, wherein the fourth corner wall, the fourth wall, and the first wall cooperatively define a fourth groove; and
a second tube positioned along the bottom edge of the first panel, wherein the second tube is uniform with the first tube;
a third tube positioned along the bottom edge of the second panel, wherein the third tube is uniform with the first tube; and
a fourth tube positioned along the top edge of the third panel, wherein the fourth tube is uniform with the first tube.

24. The garage door of claim 23, wherein the first groove and the fourth groove are configured to cooperatively receive a first seal.

25. The garage door of claim 24, wherein the second groove and the third groove are configured to cooperatively receive a second seal.

26. The garage door of claim 23, wherein the first groove, the second groove, the third groove, and the fourth groove are uniform.

27. The garage door of claim 23, wherein the first tube is comprised of a fiberglass material with a polyurethane resin base.
